(19) United States
(12) Patent Application Publication
(10) Pub. No.: US 2023/0275727 A1
(43) Pub. Date: Aug. 31, 2023

(54) POSITIONING REFERENCE SIGNAL DESIGN FOR LOW POWER TRACKING

(71) Applicants: Nokia Technologies Oy, Espoo (FI); Nokia Shanghai Bell Co., Ltd., Shanghai (CN); Nokia Solutions And Networks Oy, Espoo (FI)

(72) Inventors: Yan MENG, Shanghai (CN); Tao TAO, Shanghai (CN); Jianguo LIU, Shanghai (CN)

(21) Appl. No.: 18/005,509

(22) PCT Filed: Aug. 3, 2020
(86) PCT No.: PCT/CN2020/106597

§ 371 Date: Jan. 13, 2023

(51) Int. Cl. H04L 5/00; H04W 64/00

(52) U.S. Cl. CPC H04L 5/0051; H04W 64/00

(57) ABSTRACT

Embodiments of the present disclosure relate to devices, methods, apparatuses and computer readable storage media of PRS design for low power tracking The method comprises receiving from a second device an indication that a Sounding Reference Signal, SRS, is to be used for a positioning process of the first device unless a further indication is received; and transmitting a SRS to a third device and a fourth device, the third device being responsible for measuring a position of the first device in the positioning process. In this way, a SRS can be applied for multiple cells and the handover can be avoided or SRS resources re-configuration can be avoided even if the handover occurs at the UE. The power consumption and the positioning latency of the UE can be reduced. Meanwhile, the signalling overhead to setup RRC connection may also be reduced.

### FIELD

Embodiments of the present disclosure generally relate to the field of telecommunication and in particular, to device, method, apparatus and computer readable storage medium of Positioning Reference Signal (PRS) design for low power tracking.

### BACKGROUND

The native positioning has been supported in New Radio (NR). Some solutions are specified for NR positioning in release 16. For example, the solutions may comprise Downlink Time Difference of Arrival (DL-TDOA), Uplink Time Difference of Arrival (UL-TDOA), Downlink Angle of Departure (DL-AoD), Uplink Angle of Arrival (UL-AoA) and Multi-cell Round Trip Time (Multi-RTT). These solutions intend to enable Radio access technology (RAT) dependent and RAT independent NR positioning techniques.

In release 17, there will be further work on NR positioning with most focusing on Industrial Internet of Things (IIoT). One key objective of the research for NR positioning in release 17 may support high accuracy (horizontal and vertical), low latency, network efficiency (scalability, RS overhead, etc.), and device efficiency (power consumption, complexity, etc.) requirements for commercial uses cases.

### SUMMARY

In general, example embodiments of the present disclosure provide a solution of PRS design for low power tracking.

In a first aspect, there is provided a first device. The first device comprises at least one processor; and at least one memory including computer program codes; the at least one memory and the computer program codes are configured to, with the at least one processor, cause the first device at least to, receive from a second device an indication that a SRS is to be used for a positioning process of the first device unless a further indication is received; and transmit the SRS to a third device and a fourth device, the third device being responsible for measuring a position of the first device in the positioning process.

In a second aspect, there is provided a second device. The second device comprises at least one processor; and at least one memory including computer program codes; the at least one memory and the computer program codes are configured to, with the at least one processor, cause the second device at least to, in accordance with a determination of a low power consumption requirement at a first device, generate an indication that a SRS is to be used for a positioning process of the first device unless a further indication is received; and transmit the indication to the first device.

In a third aspect, there is provided a fourth device. The fourth device comprises at least one processor; and at least one memory including computer program codes; the at least one memory and the computer program codes are configured to, with the at least one processor, cause the fourth device at least to, in response to receiving a SRS, from a first device determine resources for transmitting the SRS; and mute the resources for transmitting the SRS.

In a fourth aspect, there is provided a method. The method comprises receiving from a second device an indication that a SRS is to be used for a positioning process of the first device unless a further indication is received; and transmitting the SRS to a third device and a fourth device, the third device being responsible for measuring a position of the first device in the positioning process.

In a fifth aspect, there is provided a method. The method comprises in accordance with a determination of a low power consumption requirement at a first device, generating an indication that a SRS is to be used for a positioning process of the first device unless a further indication is received; and transmitting the indication to the first device.

In a sixth aspect, there is provided a method. The method comprises in response to receiving a SRS from a first device, determining resources for transmitting the SRS; muting the resources for transmitting the SRS.

In a seventh aspect, there is provided an apparatus comprises means for receiving from a second device an indication that a SRS is to be used for a positioning process of the first device unless a further indication is received; and means for transmitting the SRS to a third device and a fourth device, the third device being responsible for measuring a position of the first device in the positioning process.

In an eighth aspect, there is provided an apparatus comprises means for, in accordance with a determination of a low power consumption requirement at a first device, generating an indication that a SRS is to be used for a positioning process of the first device unless a further indication is received; and means for transmitting the indication to the first device.

In a ninth aspect, there is provided an apparatus comprises means for, in response to receiving a SRS from a first device, determining resources for transmitting the SRS; and means for muting the resources for transmitting the SRS.

In a tenth aspect, there is provided a computer readable medium having a computer program stored thereon which, when executed by at least one processor of a device, causes the device to carry out the method according to the fourth aspect.

In an eleventh aspect, there is provided a computer readable medium having a computer program stored thereon which, when executed by at least one processor of a device, causes the device to carry out the method according to the fifth aspect.

In a twelfth aspect, there is provided a computer readable medium having a computer program stored thereon which, when executed by at least one processor of a device, causes the device to carry out the method according to the sixth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a signaling chart illustrating a process of PRS design for low power tracking according to some example embodiments of the present disclosure;

FIG. 3 shows a flowchart of an example method of PRS design for low power tracking according to some example embodiments of the present disclosure;

FIG. 4 shows a flowchart of an example method of PRS design for low power tracking according to some example embodiments of the present disclosure;

FIG. 5 shows a flowchart of an example method of PRS design for low power tracking according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As mentioned above, the native positioning has been supported in New Radio (NR). Some solutions are specified for NR positioning in release 16. In release 17, there will be further work on NR positioning with most focusing on Industrial Internet of Things (MT).

One of the use cases in the industry IIoT is asset tracking. Asset Tracker is a solution for tracking the locations of mobile assets, which is becoming increasingly important in improving processes and increasing flexibility in industrial environments. For example, the asset tracking device will be some smart tags with low power tags, which has the characteristics such as disposable, persistent and permanent. Therefore, this use case requires objects to combine positioning and wireless communication technologies in a cost and power efficient manner.

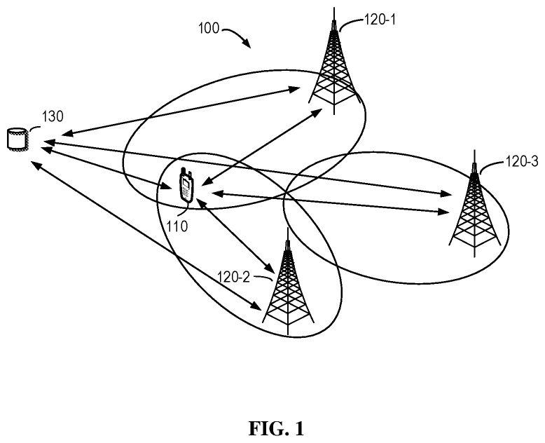

FIG. 1 shows an example communication network 100 in which embodiments of the present disclosure can be implemented. As shown in FIG. 1, the communication network 100 may comprise a terminal device 110 (hereinafter may also be referred to as UE 110 or a first device 110). The communication network 100 may further comprise a network device 120-1 (hereinafter may also be referred to as a serving gNB 120-1 or a fifth device 120-1). The network device 120-1 may be the serving gNB of the terminal device 110. The terminal device 110 may communicate with the network device 120-1.

Furthermore, the communication network 100 may further comprise network devices 120-2 and 120-3. In some scenarios, for example, a positioning process of the terminal device 110 is initiated, the network device 120-2 may measure the position of the terminal device 110 based on the reference signal received from the terminal device 110 and generate a positioning measurement report for the terminal device 110. Hereinafter the network device 120-2 may also be referred to as a measuring gNB 120-2 or a third device 120-2. In this case, the network device 120-3 may also be referred to as a non-measuring gNB 120-3 or a fourth device 120-3, which may not be responsible for the positioning measurement.

The communication network 100 may also comprise a Location Management Function (LMF) 130, which may communication with the terminal device 110 and network devices 120-1, 120-2 and 120-3. The LMF 130 may be referred to as a management node in the core network.

It is to be understood that the number of network devices and terminal devices shown in FIG. 1 is given for the purpose of illustration without suggesting any limitations. The communication network 100 may include any suitable number of network devices and terminal devices.

A Sounding Reference Signal (SRS) design supporting UL-TDOA positioning algorithms to achieve low power tracking is expected in NR. The SRS design includes aspects, such as SRS sequence generation and SRS resource configuration, etc. For example, in the communication network 100, the parameters of SRS sequence generation and the SRS transmission occasions are configured by the serving gNB 120-1. When the UE 110 moves from one cell to another cell with handover, a new serving gNB would re-configure the parameters of SRS sequence and the SRS transmission occasions, which would result in high power consumption for the asset tracking devices.

For example, the handover would introduce additional signaling overhead and complexity. When a UE access to a new gNB, it would re-setup the RRC connection with the new serving gNB. Then the UE gets SRS re-configuration information through RRC signaling from the new serving gNB.

Furthermore, the SRS resource re-configuration would introduce additional complexity and power consumption at the UE. The UE would re-generate the SRS sequence and re-map the SRS at new allocated resource, which also result to the large power consumption and complexity.

Therefore, the embodiments of the present invention propose a solution for SRS design for low power tracking. In this solution, the LMF may determine whether the UE is to be set to the low power mode based on the capability of the UE. If so, the LMF may indicate the UE that use a SRS for a positioning process unless a further indication is received, even though when the UE is to be hand over from one serving cell to another serving cell. In this way, the power consumption and the positioning latency of the UE can be reduced. Meanwhile, the signalling overhead to setup RRC connection may also be reduced.

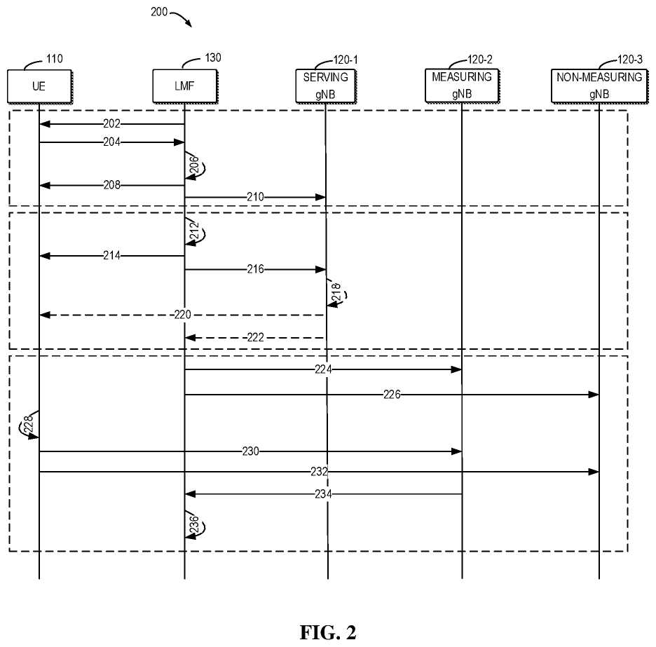

Principle and implementations of the present disclosure will be described in detail below with reference to FIGS. 2-5. FIG. 2 shows a signaling chart illustrating a process of PRS design for low power tracking according to some example embodiments of the present disclosure. For the purpose of discussion, the process 200 will be described with reference to FIG. 1. The process 200 may involve the UE 110, the serving gNB 120-1, the measuring gNB 120-2, the non-measuring gNB 120-3 and the LMF 130 as illustrated in FIG. 1.

As shown in FIG. 2, the LMF130 may send 202 a request of capability report to the UE 110. If the UE 110 receives the request, the UE 110 may generate a report comprising the capability information about the power consumption of the UE 110. For example, the capability information may comprise the type of the UE 110, such as the UE 110, for example, is a low tracking lag or the battery lifetime of the UE 110.

After generating the report, the UE 110 may transmit 204 the report to the LMF 130. Based on the report, for example, if the report indicating the UE 110 requires low power consumption, the LMF 130 may determine a low power mode of the UE 110 and generate 206 an indication that a SRS is to be used for a positioning process of the UE 110 unless a further indication is received. The indication may be considered as a low-power-mode indication. When the UE 110 receives the indication, it means that the UE 110 may not change the SRS for the positioning process even if the UE 110 is to be handover from the current serving cell to a new serving cell. Hereinafter the SRS is a reference signal that provides information about the channel quality and it may for example be a common SRS, when the SRS is common to multiple cells with respect to the UE or a dedicated SRS, specific to the UE.

Then the LMF 130 may send 208 the low-power-mode indication to the UE 110. For example, the indication may be sent from the LMF 130 to the UE 110 via a Long Term Evolution Positioning Protocol (LPP) like signaling. The LMF 130 may also send 210 the low-power-mode indication to the serving gNB 120-1 of the UE 110. When the serving gNB 120-1 receives the low-power-mode indication, the serving gNB 120-1 knows a new configuration information for SRS is not to be reconfigured for the UE 110. For example, the indication may be sent from the LMF 130 to the serving gNB 120-1 via a radio positioning protocol, such as NRPPa.

The above-described actions explain the initiation of the low-power-mode of the UE 110. Then the process of determination of the configuration information associated with the SRS may be described with the following actions. It is to be understood that the determination of the configuration information associated with the SRS and the assignment of the configuration information associated with the SRS for the UE can be occurred after the initiation of the low-power-mode. It means that the UE may be configured with configuration information associated with the SRS when the UE receives the low-power-mode indication from the LMF 130.

In some example embodiments, the configuration information associated with the SRS may be determined by the serving gNB 120-1. Alternatively, the configuration information associated with the SRS may also be determined by the LMF 130. It is also possible that the LMF 130 may transmit the configuration information associated with the SRS together with the low-power-mode indication to the UE 110.

The configuration information associated with the SRS may indicate an SRS sequence and SRS transmission occasions. The SRS transmission occasions including at least the time/frequency resource allocation, port number, periodicity, etc.

For the SRS sequence, in general, if a UE access to a new gNB, the gNB shall determine new SRS sequence according to its own preference. Therefore, the UE needs to re-generate the SRS sequence when it accesses to the new cell. This will result addition overhead and UE complexity.

To reduce the complexity, the configuration information associated with the SRS of the present disclosure may design a dedicated SRS sequence for the UE, where the index of the SRS sequence can be bundled with the index of the UE.

For example, a SRS sequence is based on the Zadoff-Chu sequence given by r_{u,v}^{(α,δ)}(n), which is defined by a cyclic shift α of a base sequence r̅_{u,v}(n) according to

r_{u,v}^{(α,δ)}(n)=e^{jαn}r̅_{u,v}(n), 0≤n<M_{ZC} (1)

Where M_{ZC}=mN_{SC}^{RB}/2^{δ} is the length of the sequence and δ is the comb size. Multiple sequences are defined from a single base sequence through different values of α and δ. The definition of the base sequence r̅_{u,v}(0), . . . , r_{u,v}(M_{ZC}−1) depends on the sequence length M_{ZC}, with computer generated sequences under or equal to a length of 36, and ZC sequences above, u and v are respectively the group and sequence number in the group, which are the functions of the higher layer parameter sequenceId n_{ID}^{SRS}.

For example, if we should not support the group or sequence hopping for lower complexity, the base sequence in that group is the first sequence (v=0), the group u is entirely defined by the SRS sequence ID parameter sequenceId n_{ID}^{SRS} as follows:

u=n_{ID}^{SRS} mod 30 (2)

In order to fix the SRS sequence, the sequence ID n_{ID}^{SRS} can be bundled with the index of the UE 110 (for example, the tag index of the UE 110). For example, the dedicated SRS sequence for the UE 110 can be represented as:

$$\{ \begin{matrix}{n}_{ID}^{SRS} = {n}_{ID}^{Tag} , {N}_{Tag} \leq {N}_{SRS} \\ {n}_{ID}^{SRS} = {n}_{ID}^{Tag} mod {N}_{SRS} , {N}_{Tag} > {N}_{SRS}\end{matrix} \qquad ( 3 )$$

Where N_{Tag} is the number of Tags in one RAN tracking area, n_{ID}^{Tag} is the Tag index, and N_{SRS} is the number of sequence ID supported in the current system.

It is to be understood that when multiple UEs share the same sequence ID n_{ID}^{SRS} or sequence group u, the different parameters such as cyclic shift, and comb size may be configured for the SRS sequences of different UE to avoid collision.

As an option, the parameters of SRS sequence generation and SRS transmission occasion can be determined at LMF 130. The LMF 130 may configure one SRS resource that try to satisfy the requirements of all the gNBs in one RAN tracking area. For example, the LMF 130 may collect the assisted information from the gNBs and UEs in one RAN tracking area, such as the UE 110 and the gNB 120-1 shown in FIG. 1. The assisted information of the gNBs may comprise the following information such as traffic load, Downlink/Uplink sub-frame structure, SRS resource usage and interference level. The assisted information of the UE may comprise the capability of the UE such as the supported band and the port number.

Based on the assisted information, as shown in FIG. 2, the LMF 130 may determine 212 the configuration information associated with the SRS. Then the LMF 130 may transmit 214 the configuration information associated with the SRS to the UE 110, for example, via a LPP signalling. The LMF 130 may also transmit 216 the configuration information associated with the SRS to the serving gNB 120-1, for example, via a NRPPa signalling.

As another option, the parameters of SRS sequence generation and SRS transmission occasion can be determined at serving gNB 120-1. For example, the serving gNB 120-1 may determine 218 the parameters of SRS sequence generation and SRS transmission occasion based on traffic load, Downlink/Uplink sub-frame structure, SRS resource usage and interference level. Then the serving gNB 120-1 may transmit 220 the configuration information associated with the SRS to the UE 110, for example, via a RRC signalling. The serving gNB 120-1 may also transmit 220 the configuration information associated with the SRS to the LMF 130, for example, via a NRPPa signalling.

After the UE receives the configuration information associated with the SRS, when the UE moves to, for example, the edge of the coverage of the serving gNB 120-1, a positioning process for the UE 110 may be initiated.

For the positioning process for the UE 110, the LMF 130 may indicate the measuring gNBs around the serving cells of the UE 110, for example, the measuring gNB 120-2 to perform the positioning measurement with configuration of UL positioning assistance information. For example, the LMF 130 may transmit 224 the configuration information associated with the SRS configured for the UE 110 to the measuring gNB 120-2.

When the UE 110 moves to one new cell, the UL SRS transmission of the UE 110 for the positioning process may interfere with the other UL transmission of UEs in the new cell. Thus, to avoid the interference to other UL transmission, the LMF 130 may also transmit 226 the configuration information associated with the SRS configured for the UE 110 to the non-measuring gNBs, for example, the non-measuring gNB 120-3.

Based on the received SRS configuration, the UE 110 may generate 228 the SRS and transmit 230 the UL SRS to the measuring gNB 120-2 for the positioning measurement on the SRS transmission occasion.

Based on the UL positioning assistance information provided by the LMF 130, the measuring gNB 120-2 may perform positioning measurement during the window of SRS transmission occasions and transmit 234 the measurement report to the LMF 130. Then the LMF 130 may perform 236 a location calculation of the UE 110 based on the measurement report.

The UE 110 may also transmit 232 the UL SRS to the non-measuring gNB 120-3. When the non-measuring gNB 120-3 receives the UL SRS based on the UL positioning assistance information provided by the LMF 130, the non-measuring gNB 120-3 may determines the resources for transmitting the SRS and mute the SRS transmission on the SRS transmission occasion.

In some example embodiments, the first device 110 may determine whether the interference level from the SRS transmission exceeds a threshold level. If the non-measuring gNB 120-3 determines the interference level from the SRS transmission exceeds a threshold level, to avoid the interference, the non-measuring gNB 120-3 may mute the SRS transmission.

If the non-measuring gNB 120-3 determines the interference level from the SRS transmission is lower than the threshold level, it may not be necessary to mute the resource to improve the resource utilization.

In this way, the power consumption and the positioning latency of the UE can be reduced. Meanwhile, the signalling overhead to setup RRC connection may also be reduced.

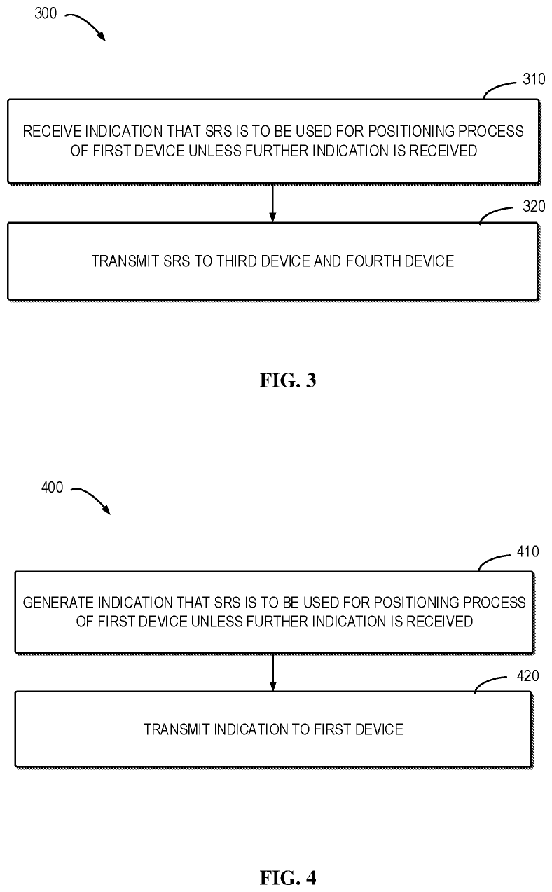

FIG. 3 shows a flowchart of an example method 300 of PRS design for low power tracking according to some example embodiments of the present disclosure. The method 300 can be implemented at the first device 110 as shown in FIG. 1. For the purpose of discussion, the method 300 will be described with reference to FIG. 1.

At 310, the first device 110 receives, from a second device 120, an indication that a SRS is to be used for a positioning process of the first device unless a further indication is received.

In some example embodiments, the first device 110 may determine capability information about power consumption of the first device; and transmit a capability report to the second device based on the capability information.

At 320, the first device 110 transmits the SRS generated to a third device 120-2 and a fourth device 120-3, the third device 120-2 being responsible for measuring a position of the first device 110 in the positioning process and the fourth device 120-3 being different from the third device 120-2.

In some example embodiments, the first device 110 may receive configuration information associated with SRS indicating a target SRS sequence associated with an index of the first device and a transmission occasion of the SRS.

In some example embodiments, the configuration information associated with the SRS is received from the second device via a long term evolution positioning protocol signaling.

In some example embodiments, the configuration information associated with the SRS is received from a fifth device 120-1 serving the first device via a radio resource control signaling.

In some example embodiments, the SRS is generated based on a SRS sequence associated with an index of the first device, the SRS sequence determined based on the configuration information associated with the SRS.

In some example embodiments, if the first device determines the first device is to be hand over from a serving cell to a target cell, the first device may generate the SRS based on the configuration information associated with the SRS and determine a transmission occasion of the SRS based on the configuration information associated with the SRS.

In some example embodiments, the first device comprises a terminal device, the second device comprises a location management function, the third device comprises a network device and the fourth device comprises a network device.

In some example embodiments, the fifth device comprises a network device.

FIG. 4 shows a flowchart of an example method 400 of PRS design for low power tracking according to some example embodiments of the present disclosure. The method 400 can be implemented at the second device 130 as shown in FIG. 1. For the purpose of discussion, the method 400 will be described with reference to FIG. 1.

At 410, the second device 130 generates an indication that a Sounding Reference Signal, SRS configuration is to be used for a positioning process of the first device unless a further indication is received if the second device 130 determines a low power consumption requirement at a first device.

In some example embodiments, if the second device 130 receives the capability report from the first device, the second device 130 may determine low power consumption requirement based on the capability information about the power consumption of the first device determined from the capability report.

At 420, the second device 130 transmits the indication to the first device.

In some example embodiments, the second device 130 may generate configuration information associated with SRS indicating a target SRS sequence associated with an index of the first device and a transmission occasion of the SRS; and transmit the configuration information associated with the SRS to the first device via a long term evolution positioning protocol signaling.

In some example embodiments, the second device 130 may determine a reference SRS sequence and generate the target SRS sequence for the first device based on the reference SRS sequence and the index of the first device. The second device may further determine the transmission occasion of the SRS and generating the configuration information associated with the SRS based on the target SRS sequence and the transmission occasion.

In some example embodiments, the second device 130 may obtain the configuration information associated with the SRS from a fifth device serving the first device via a radio positioning protocol.

In some example embodiments, the second device 130 may generate positioning assistance information at least based on the configuration information associated with the SRS; and transmit the positioning assistance information to a third device and a fourth device, the third device being responsible for measuring a position of the first device in the positioning process.

In some example embodiments, the second device 130 may transmit the configuration information associated with the SRS to a fifth device serving the first device via a radio positioning protocol.

In some example embodiments, the second device 130 may transmit the indication to a fifth device serving the first device, a third device and a fourth device, the third device being responsible for measuring a position of the first device in the positioning process.

In some example embodiments, the first device comprises a terminal device and the second device comprises a location management function.

In some example embodiments, the third device comprises a network device and the fourth device comprises a network device.

In some example embodiments, the fifth device comprises a network device.

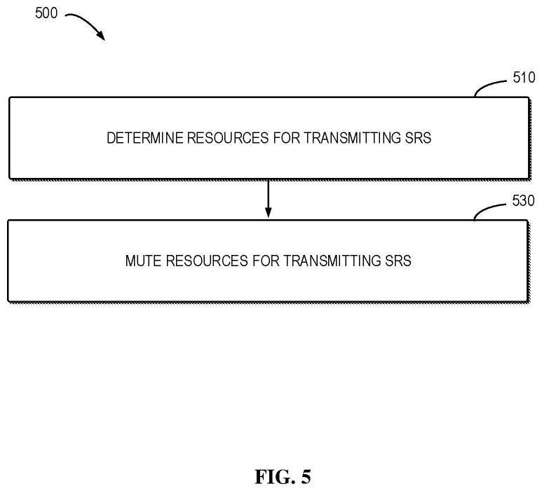

FIG. 5 shows a flowchart of an example method 500 of PRS design for low power tracking according to some example embodiments of the present disclosure. The method 500 can be implemented at the fourth device 120-3 as shown in FIG. 1. For the purpose of discussion, the method 500 will be described with reference to FIG. 1.

At 510, the fourth device 120-3 determines resources for transmitting the SRS if the fourth device 120-3 receives the SRS from a first device.

At 520, the fourth device 120-3 mutes the resources for transmitting the SRS.

In some example embodiments, the fourth device 120-3 may receive positioning assistance information from a second device, the positioning assistance information at least comprising SRS configuration used for a positioning process of the first device, determines the interference level of the SRS and the resources for transmitting the SRS based on the configuration information associated with the SRS. If the fourth device determines the interference level exceeds a threshold level, the fourth device may mute the resources for transmitting the SRS.

In some example embodiments, the first device comprises a terminal device and the fourth device comprises a network device.

In some example embodiments, the second device comprises a location management function.

In some example embodiments, an apparatus capable of performing the method 300 (for example, implemented at the UE 110) may comprise means for performing the respective steps of the method 300. The means may be implemented in any suitable form. For example, the means may be implemented in a circuitry or software module.

In some example embodiments, the apparatus comprises means for receiving from a second device an indication that a SRS is to be used for a positioning process of the first device unless a further indication is received; and means for transmitting the SRS to a third device and a fourth device, the third device being responsible for measuring a position of the first device in the positioning process.

In some example embodiments, an apparatus capable of performing the method 400 (for example, implemented at the LMF 130) may comprise means for performing the respective steps of the method 400. The means may be implemented in any suitable form. For example, the means may be implemented in a circuitry or software module.

In some example embodiments, the apparatus comprises means for, in accordance with a determination that an expected level of power consumption of a first device is lower than a threshold level, generating an indication that a SRS is to be used for a positioning process of the first device unless a further indication is received; and means for transmitting the indication to the first device.

In some example embodiments, an apparatus capable of performing the method 500 (for example, implemented at the non-measuring gNB 120-3) may comprise means for performing the respective steps of the method 500. The means may be implemented in any suitable form. For example, the means may be implemented in a circuitry or software module.

In some example embodiments, the apparatus comprises means for, in response to receiving a SRS from a first device, determining an interference level of the SRS; and means for, in accordance with a determination that the interference level exceeds a threshold level, muting the transmission of the SRS.

FIG. 6 is a simplified block diagram of a device 600 that is suitable for implementing embodiments of the present disclosure. The device 600 may be provided to implement the communication device, for example the UE 110, the LMF130 and the non-measuring gNB 120-3 as shown in FIG. 1. As shown, the device 600 includes one or more processors 610, one or more memories 620 coupled to the processor 610, and one or more transmitters and/or receivers (TX/RX) 640 coupled to the processor 610.

The TX/RX 640 is for bidirectional communications. The TX/RX 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 620. The processor 610 may perform any suitable actions and processing by loading the program 630 into the RAM 620.

The embodiments of the present disclosure may be implemented by means of the program 630 so that the device 600 may perform any process of the disclosure as discussed with reference to FIGS. 2 to 5. The embodiments of the present disclosure may also be implemented by hardware or by a combination of software and hardware.

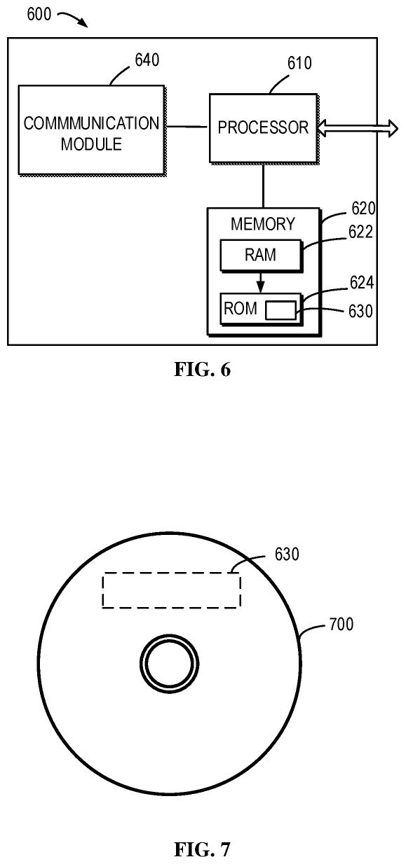

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7. shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 300, 400 and 500 as described above with reference to FIGS. 3-5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-56. (canceled)

57. A first device comprising:
at least one processor; and
at least one memory including computer program code;
the at least one memory and the computer program code are configured to, with the at least one processor, cause the first device at least to:
receive from a second device an indication that a Sounding Reference Signal, SRS, is to be used for a positioning process of the first device unless a further indication is received; and
transmit the SRS to a third device, the third device being responsible for measuring a position of the first device in the positioning process.

58. The first device of claim 57, wherein the first device is further caused to:
determine capability information about power consumption of the first device; and
transmit a capability report to the second device based on the capability information.

59. The first device of claim 57, wherein the first device is further caused to:
receive configuration information associated with SRS indicating a target SRS sequence associated with an index of the first device and a transmission occasion of the SRS.

60. The first device of claim 57, wherein the SRS is generated based on a SRS sequence associated with an index of the first device, the SRS sequence determined based on configuration information associated with SRS.

61. The first device of claim 57, wherein the first device is caused to transmit the SRS by:
in accordance with a determination that the first device is to be hand over from a serving cell to a target cell, generating the SRS based on configuration information associated with SRS;
determining a transmission occasion of the SRS based on the configuration information; and
transmitting the SRS on the transmission occasion.

62. The first device according to claim 57, wherein the SRS is transmitted to a fourth device and resources on which the SRS is transmitted is to be muted by the fourth device.

63. A second device comprising:
at least one processor; and
at least one memory including computer program code;
the at least one memory and the computer program code are configured to, with the at least one processor, cause the second device at least to:
in accordance with a determination of a low power consumption requirement at a first device, generate an indication that a Sounding Reference Signal, SRS, is to be used for a positioning process of the first device unless a further indication is received; and
transmit the indication to the first device.

64. The second device of claim 63, wherein the second device is further caused to:
in response to receiving a capability report from the first device, determine the low power consumption requirement based on the capability information about the power consumption of the first device determined from the capability report.

65. The second device of claim 63, wherein the second device is further caused to:
generate configuration information associated with SRS indicating a target SRS sequence associated with an index of the first device and a transmission occasion of the SRS; and
transmit the configuration information to the first device via a long term evolution positioning protocol signaling.

66. The second device of claim 65, wherein the second device is caused to generate the configuration information by:
determining a reference SRS sequence;
generating the target SRS sequence for the first device based on the reference SRS sequence and the index of the first device;
determining the transmission occasion of the SRS; and
generating the configuration information based on the target SRS sequence and the transmission occasion.

67. The second device of claim 63, wherein the second device is further caused to:
obtain the configuration information from a fifth device serving the first device via a new radio positioning protocol signaling A.

68. The second device of any of claim 65, wherein the second device is further caused to:
generate positioning assistance information at least based on the configuration information; and
transmit the positioning assistance information to a third device and a fourth device, the third device being responsible for measuring a position of the first device in the positioning process.

69. The second device of claim 65, wherein the second device is further caused to:
transmit the configuration information to a fifth device serving the first device via a radio positioning protocol.

70. The second device of claim 63, wherein the second device is further caused to:
transmit the indication to a fifth device serving the first device, a third device and a fourth device, the third device being responsible for measuring a position of the first device in the positioning process.

71. A fourth device comprising:
at least one processor; and
at least one memory including computer program code;
the at least one memory and the computer program code are configured to, with the at least one processor, cause the fourth device at least to:
in response to receiving a Sounding Reference Signal, SRS, from a first device, determine resources for transmitting the SRS; and
mute the resources for transmitting the SRS.

72. The fourth device of claim 71, wherein the fourth device is caused to mute the resources for transmitting the SRS by:
receiving positioning assistance information from a second device, the positioning assistance information at least comprising SRS configuration used for a positioning process of the first device;
determining the interference level of the SRS and the resources for transmitting the SRS based on configuration information associated with SRS; and
in accordance with a determination that the interference level exceeds a threshold level, mute the resources for transmitting the SRS.

73. A method comprising:
receiving, at a first device and from a second device an indication that a Sounding Reference Signal, SRS, is to be used for a positioning process of the first device unless a further indication is received; and
transmitting a SRS to a third device, the third device being responsible for measuring a position of the first device in the positioning process.

74. The method of claim 73, further comprising:
determining capability information about power consumption of the first device; and
transmitting a capability report to the second device based on the capability information.

75. The method of claim 73, further comprising:
receiving configuration information associated with SRS indicating a target SRS sequence associated with an index of the first device and a transmission occasion of the SRS.

76. The method of claim 73, wherein the SRS is generated based on a SRS sequence associated with an index of the first device, the SRS sequence determined based on configuration information associated with SRS.

77. The method of claim 73, wherein transmit the SRS comprises:
in accordance with a determination that the first device is to be hand over from a serving cell to a target cell, generating the SRS based on configuration information associated with SRS;
determining a transmission occasion of the SRS based on the configuration information; and
transmitting the SRS on the transmission occasion.

78. The method of claim 73, wherein the SRS is transmitted to a fourth device and resources on which the SRS is transmitted is to be muted by the fourth device.
